(19) United States
(12) Patent Application Publication
(10) Pub. No.: US 2007/0067294 A1
(43) Pub. Date: Mar. 22, 2007

(54) Readability and context identification and exploitation

(76) Inventors: David W. Ward, Somerville, MA (US); Sabine M. Volkmer, Somerville, MA (US)

Correspondence Address: GOODWIN PROCTER LLP;PATENT ADMINISTRATOR, EXCHANGE PLACE, BOSTON, MA, 02109-2881, US

(21) Appl. No.: 11/522,746

(22) Filed: Sep. 18, 2006

Related U.S. Application Data
(60) Provisional application No. 60/812,259, filed on Jun. 9, 2006.
(60) Provisional application No. 60/719,323, filed on Sep. 21, 2005.

(51) Int. Cl. G06F 7/00

(52) U.S. Cl. 707/7

(57) ABSTRACT

Search systems and methods address the subjective nature of the relevancy of matches to users' queries through the use of readability formulae. As a result, the documents are ranked by relevance not only to user queries, but specifically to the user. In one approach, the searchable web (or a searchable corpus of documents) is categorized on one or more servers. Each document is designated by reading level or other parameter(s) relevant to the user's reading ability. In one embodiment, searching is carried out utilizing the user's search query, and documents are ranked based on relevance to the query and on their degree of readability to the user—e.g., the degree to which the contents of each document correspond to the user's reading level. Advertisement displays may be targeted to both the search tokens entered and the user's age as determined from his reading level, rendering search-related advertisements significantly more effective in reaching their intended audiences.

### CROSS-REFERENCE TO RELATED APPLICATION

The present application claims the benefits of and priority to U.S. Provisional Application Ser. Nos. 60/812,259 (filed on Jun. 9, 2006 and entitled “Web Browser Module for Readability and Context Identification and Adjustment”) and 60/719,323 (filed on Sep. 21, 2005 and entitled “Ranking Search Results with Readability Formulae”) the entire disclosures of which are hereby incorporated by reference.

### FIELD OF THE INVENTION

This invention generally relates to the Internet searching, and more specifically to intelligently ranking possible matches to user queries.

### BACKGROUND

The Internet is a worldwide “network of networks” that links many millions of computers through tens of thousands of separate (but intercommunicating) networks. Via the Internet, users can access tremendous amounts of stored information and establish communication linkages to other Internet-based computers.

Much of the Internet is based on the client-server model of information exchange. This computer architecture, developed specifically to accommodate the “distributed computing” environment that characterizes the Internet and its component networks, contemplates a server (sometimes called the host)—typically a powerful computer or cluster of computers that behaves as a single computer—that services the requests of a large number of smaller computers, or clients, which connect to it. The client computers usually communicate with a single server at any one time, although they can communicate with one another via the server or can use the server to reach other servers. A server is typically a large mainframe or minicomputer cluster, while the clients may be simple personal computers.

The Internet supports a large variety of information-transfer protocols. One of these, TCP/IP, underlies the World Wide Web (hereafter, simply, the “web”)—an information space which has attained such importance that, to many, the Internet is synonymous with the web. Web-accessible information is identified by a uniform resource locator or “URL,” which specifies the location of the file in terms of a specific computer and a location on that computer. Any Internet “node”—that is, a computer with an IP address (e.g., a server permanently and continuously connected to the Internet, or a client that has connected to a server and received a temporary IP address)—can access the file by invoking the proper communication protocol and specifying the URL. Typically, a URL has the format http://<host>/<path>, where “http” refers to the HyperText Transfer Protocol, “host” is the server's Internet identifier, and the “path” specifies the location of the file within the server. Each “web site” can make available one or more web “pages” or documents, which are formatted, tree-structured repositories of information, such as text, images, video, sounds and animations.

An important feature of the web is the ability to connect one document to many other documents using “hypertext” links. A link appears unobtrusively as an underlined portion of text in a document; when the viewer of this document moves his cursor over the underlined text and clicks, the link—which is otherwise invisible to the user—is executed and the linked document retrieved. That document need not be located on the same server as the original document.

Hypertext and searching functionality on the web is typically implemented on the client machine using a “web browser.” With the client connected as an Internet node, the browser utilizes URLs—provided either by the user or a link—to locate, fetch and display the specified documents. “Display” in this sense can range from simple pictorial and textual rendering to real-time playing of audio and/or video segments or alarms, mechanical indications, printing, or storage of data for subsequent display. The browser passes the URL to a protocol handler on the associated server, which then retrieves the information and sends it to the browser for display; the browser causes the information to be cached (usually on a hard disk) on the client machine. The web page itself contains information specifying the specific Internet transfer routine necessary to retrieve the document from the server on which it is resident. Thus, clients at various locations can view web pages by downloading replicas of the web pages, via browsers, from servers on which these web pages are stored. Browsers also allow users to download and store the displayed data locally on the client machine.

Accordingly, to access a web-based document directly, the user types its URL into the address bar of a web browser. But this is an inefficient way of navigating the web, as the content of a website is not always obvious simply from the URLs of its pages. Search engines were created to circumvent this difficulty.

A search engine provides a way for users to search the web for websites having information in which they are interested. The user enters a set of search tokens into the search bar, and the search engine returns a set of matches in the form of hyperlinks to web pages of possible interest.

Much of the evolution of search engine technology has focused on increasing the number of web pages archived and the speed with which matches are retrieved, and on providing the best possible matches to users' queries, i.e., a set of web pages that will be closest to the user's interest. Since users' interests are highly subjective, this is not an easy task. Early search engines relied solely on the number of occurrences of the search tokens in the indexed corpus of web pages archived by the search engine. One of the more recent advances involved re-ranking a set of initial search results obtained as described before, based on the number of other web sites that link to the page. Such advances in search engine technology, however, have not recognized and exploited the fact that relevancy is a largely subjective matter, and that the usefulness of a web page to a reader depends not only on its contents, but on the user's ability to comprehend those contents.

### DESCRIPTION OF THE INVENTION

### Brief Summary of the Invention

The present invention provides systems and methods that address the subjective nature of the relevancy of matches to users' queries through the use of readability formulae. As a result, the documents are ranked by relevance not only to user queries, but specifically to the user. In one approach, the searchable web (or a searchable corpus of documents) is categorized on one or more servers. Each document is designated by reading level or other parameter(s) relevant to the user's reading ability. In one embodiment, searching is carried out utilizing the user's search query, and documents are ranked based on relevance to the query and on their degree of readability to the user—i.e., the degree to which the contents of each document correspond to the user's reading level. But numerous variations are possible. For example, retrieval as well as ranking can be based in part on reading level. In one such approach, the corpus of searchable documents is segmented according to reading level, and searching based on the user's query is confined to documents that have been assigned reading levels at or below that of the user. Alternatively, the documents presented to the user may exclude those below (or too far below) the user's reading level. The degree to which query relevance and readability influence ranking and/or searching can also be varied, e.g., by a weighting assigned automatically or by the user. For example, documents retrieved as relevant to the search query but with reading levels above that of the user may be ranked below those more relevant in terms of query matching, or may not be ranked at all (i.e., excluded altogether from the list presented to the user).

Each item in the list of documents presented to the user is preferably a hyperlink to the relevant web page or item. It should be stressed, however, that the invention is not limited to retrieval of web pages. It may also be used in searching any electronic corpus for documents to support “learn to read” programs or English as a second language, for example.

Information defining the user's reading level or readability preferences may be provided voluntarily by the user, either by directly entering his age or grade/education level, or indirectly, e.g., by setting a sliding tool bar to the desired difficulty level. In the latter case, the user's age can be inferred from his reading level in good approximation, since reading level and age correlate strongly.

Information about the user's age can be utilized by Internet advertisers to better target their audiences. In conventional search advertising, advertisers provide keywords which, if entered by a search engine user as a search token, prompt the display of the ad. In this way, advertisers try to direct their ads to people who are likely interested in their products or services. A search token alone, however, provides only limited information about the user's interest and is often not sufficient to make a good guess at the user's age. In tying advertisement displays to both the search tokens entered and the user's age as determined from his reading level, search-related advertisements can be made significantly more effective in reaching their intended audiences.

The targeting of search advertisement can be even further improved if additional information about the user is available. Such information may, for instance, result from the user's registration with the search engine, in which he (voluntarily) provides additional personal information, or from a user profile derived from his search history and general online behavior (including metrics such as time spent on a website, links followed, words moused over, etc.).

### BRIEF DESCRIPTION OF THE DRAWINGS

The foregoing discussion will be understood more readily from the following detailed description of the invention, when taken in conjunction with the accompanying drawings, in which:

FIG. 1 is a block diagram illustrating a web server implementing a server-based approach to the present invention;

FIG. 2 schematically illustrates in greater detail the operation of the web server shown in FIG. 1;

FIG. 3 is a flow chart detailing the calculation and assignment of readability scores to a document according to one embodiment of the invention;

FIG. 4 schematically illustrates a search process in accordance with one embodiment of the invention; and

FIG. 5 schematically illustrates a client-side implementation of the present invention.

### DETAILED DESCRIPTION OF THE PREFERRED EMBODIMENT

The present invention may be implemented at the client side, at the server side, or some combination. In general, however, this will not affect the user's experience in employing the invention, which need not vary regardless of where particular elements of functionality are carried out.

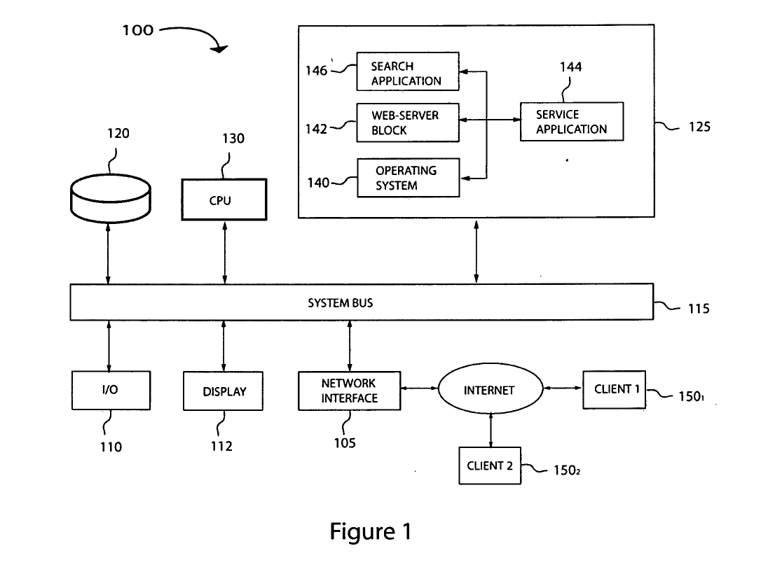

FIG. 1 illustrates, in block-diagram form, a server 100 implementing a search site in accordance with the invention. (As used herein, the term “site” refers to any interactive product, site or area, including but not limited to a site on the World Wide Web portion of the Internet.) As indicated in the figure, the server 100 includes a network interface 105, which enables the server 100 to interact, via a computer network (typically the Internet), with visitors to the site. The site manager interacts with the server 100 by means of input/output devices 110 (a keyboard, a mouse or other position-sensing device, etc.) and a screen display 112. The system further includes a bidirectional system bus 115, over which the system components communicate, a non-volatile mass storage device (such as one or more hard disks and/or optical storage units) 120, and a main (typically volatile) system memory 125. The operation of the server 100 is directed by a central-processing unit (“CPU”) 130.

The main memory 125 contains instructions, conceptually illustrated as a group of modules, that control the operation of CPU 130 and its interaction with the other hardware components. An operating system 140 directs the execution of low-level, basic system functions such as memory allocation, file management and operation of mass storage devices 120. At a higher level, a web-server block 142 implementing HTTP handles requests for the web pages that will be transmitted, via network interface 105, to site visitors. The analysis and ranking functions of the invention are implemented by a service application 144, and document searching is accomplished by a conventional search application 146. Client computers 150₁, 150₂ interact with the server 100 via the Internet. Using client computers 150, users enter queries and reading-level parameters. These are transmitted to server 100, which carries out document searching via application 146. The raw retrieval results are analyzed by application 144 and the results reported back, as a ranked list of document hyperlinks, to clients 150.

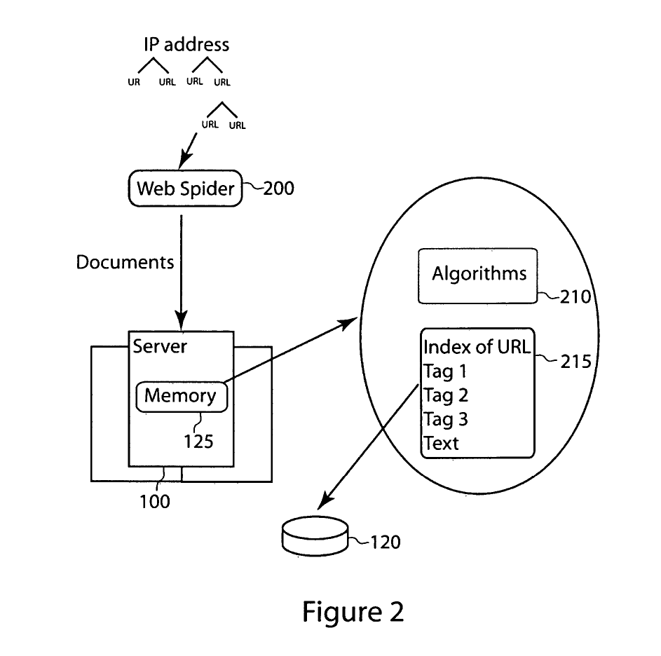

FIG. 2 illustrates the operation of one embodiment of server 100 (which, it should be understood, may be implemented as a single server or, more typically, as multiple interoperating servers). The search application 146 includes a web spider 200, which “crawls” the Internet (or other computer network) in search of documents containing text, i.e., URLs and the corresponding (new) texts stored on the network. These documents, or some portion thereof (e.g., the first 100 kbytes), are received at server 100, where they are loaded into the server's memory 125.

In order to assign readability levels to each document, service application 144 utilizes a series of algorithms 210, e.g., a document-characterizing algorithm and one or more readability-assessment algorithms. Based on these algorithms, CPU 130 calculates certain metrics of each text document, such as, for example, the average number of words per sentence or the average number of syllables per word (see below for further metrics). These metrics are subsequently used to calculate, for each document, parameters representing the readability level of this document in accordance with the formulae implemented by the readability algorithm(s). The parameters are then stored in tags (i.e., special headings within the index of an archived document) associated with the corresponding documents. For example, the index 215 to a given document may include a title and text body (and any other relevant information about the document), along with the tags noted above. The index 215 also includes the URL of the document, and is saved on storage device 120. Similar indices are generated for all URLs found by the web spider 200 and represent a corpus of searchable documents.

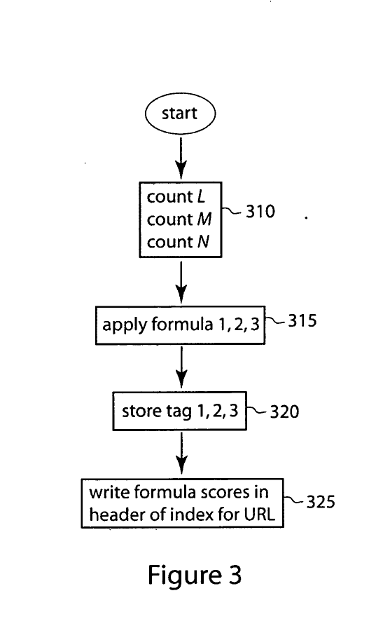

The operation of algorithms 210 is shown in FIG. 3. In order to provide some context for the specifics underlying these algorithms, the concept of readability as well as several established methods of its quantification will first be described.

Not every aspect of what interests a particular user can be encapsulated in readability formulae, but linear regression studies that correlate reading level to simple metrics like average word length, number of syllables, sentences per paragraph, and sentence length have proven effective elsewhere. For example, such formulae have been employed for years by textbook selection committees in choosing age-appropriate reading material for children in a particular grade. Writers often use them to gauge how effectively what they write will appeal to a certain audience.

The term “reading level” is used herein to indicate the chronological age of a reader who can just understand the document being rated and is the quantitative representation of the readability of a document. For example, a web page rated “5” may be read and comprehended by a reader aged five years or older. As an example, consider the following sentences:

1. A short sentence like this needs a reading level of less than nine years.

2. A longer sentence, which contains an adjectival clause and polysyllabic words, requires a reading level of at least sixteen years.

Years of research have established the quantifiability of readability, which is validated by a strong correlation with both reading comprehension and reader interest. Stated negatively, people are not interested in what they cannot understand. Admittedly, a reader's comprehension of a document does not guarantee his interest in that document, but the converse is statistically true. Assessing whether a document is suitable for a reader of a particular age can be accomplished in one of four major ways.

In a first approach, a question-and-answer technique is employed in which readers of different ages are given the same document to read and each is subsequently tested on comprehension of its contents. The results are then compiled and the document reading level is rated based on the statistical outcome of the tests.

The “Cloze” technique involves the deletion of the n^{th} word from a document, and readers of different age are instructed to fill in the missing words. The ability of readers of a particular age to accurately complete the sentence is used to gauge the appropriate reading level. This is accomplished statistically, as before.

Another rating system is based on a comparison of the document to a pre-compiled word list. One popular list is the Dale list. The document is rated based on the number of words not contained on this list, and a numeric reading level is scaled based on linear regression of the statistical results. These three techniques, it will be appreciated, are tedious to apply.

The preferred approach is the use of reading formulae based on structural metrics such as number of words per sentence, number of syllables per word, sentence length, and number of sentences per paragraph. The reading level predicted by these formulae corresponds to the average reader of a particular age. There are many such formulae, though not all have shown equally strong correlation to reading level. These formulae most often return a numerical quantity corresponding to the expected minimum grade level required to comprehend the document, but these can be rescaled to indicate chronological age, as before.

One preferred formula is the Gunning ‘FOG’ readability test, which selects three samples of 100 words a piece from a document. The average sentence length L (number of words divided by number of sentences) is calculated to the nearest tenth. In each sample, the number of words with three or more syllables is averaged and stored in the value M. The reading level is then (L+M)*0.4 in American grade level or [(L+M)*0.4]+5 years in chronological age. This method is suitable for secondary and older primary age groups.

Another useful formula is the Fry readability graph, which represents reading level in chronological age on a two-dimensional graph. The average number of sentences per 100-word passage is graphed along one axis, and the average number of syllables per 100-word sample is graphed along the other. Points corresponding to average documents fall on the curves displayed on the Fry graph. Points lying below this curve imply longer than average sentences, while points lying above imply a more difficult vocabulary.

In the Flesh-Kincaid formula, the average sentence length L, and average syllables per word N, are related to reading level by (L*0.39)+(N*11.8)−15.59 in American grade level or (L*0.39)+(N*11.8)−10.59 years in chronological age. This test is most suitable for adults.

The Powers-Sumner-Kearl formula is most suitable for primary age readers (ages 7-10), but not generally suitable for readers above 10 years old. L and N are calculated the same as before. The reading level is then (L*0.0778)+(N*0.0455)−2.2029 in American grade level and (L*0.0778)+(N*0.0455)+2.7971 years in chronological age.

More specialized tests may also be employed. For example, the McLaughlin ‘SMOG’ formula is used to ensure 100% comprehension of the text at the indicated reading level. It therefore tends to rate documents with a higher numerical value than the other tests. The test selects samples of 30 consecutive sentences. In each sample the average number of words with three or more syllables M is calculated. The reading level is given by M^{0.5}+3 in American grade level or M^{0.5}+8 years in chronological age. Another example is the FORCAST formula, which was devised for assessing US army technical manuals and is not suitable for primary ages, but it is the only formula that does not need whole sentences. In this test, the number of single syllable words O per 150 words is calculated. The reading level is then 20-O/10 in American grade level or 25-O/10 years in chronological age.

Ultimately, the goal of a search engine is to deliver the best possible set of matches to a user's query. It is therefore desirable to provide search algorithms that refine search results to best suit the users' interests. As stated earlier, this is highly subjective, and any such algorithm should be tailored to each particular user. Though age, or grade level, is the metric rendered by the formulae described herein, this is by way of illustration only. Similar formulae may be used to render a numerical score that distinguishes documents according to appropriateness for certain trades or fields as well, e.g., Army, Navy, and Air Force documents.

With reference to FIG. 3, in a first step 310, certain metrics of the text, such as the average number of words per sentence L, the average number of syllables per word N, and the average number of words with three or more syllables M are calculated. Other useful metrics include, for example, the average number of words or sentences per paragraph, the ratio of consonants to vowels, the number of single-syllable words, the number of words occurring in a pre-compiled wordlist, the average number of unrecognized characters, etc. The generality of the present invention is not limited by the aforementioned metrics and may include others not mentioned here.

In step 315, readability formulae are used to calculate readability scores from these metrics. In the illustration, three formulae are used. Formula 1 may, for instance, be Powers-Sumner-Kearl, applicable for users age 5 and younger, formula 2 may be Gunning-Fog, applicable for users of age 6 to 12, and formula 3 may be Flesch-Kincaid, applicable for users 13 and older.

In step 320, the readability scores that result from the application of readability formula are stored in tags 1, 2, and 3, and these are written in the header of the index for the URL corresponding to the analyzed document (step 325).

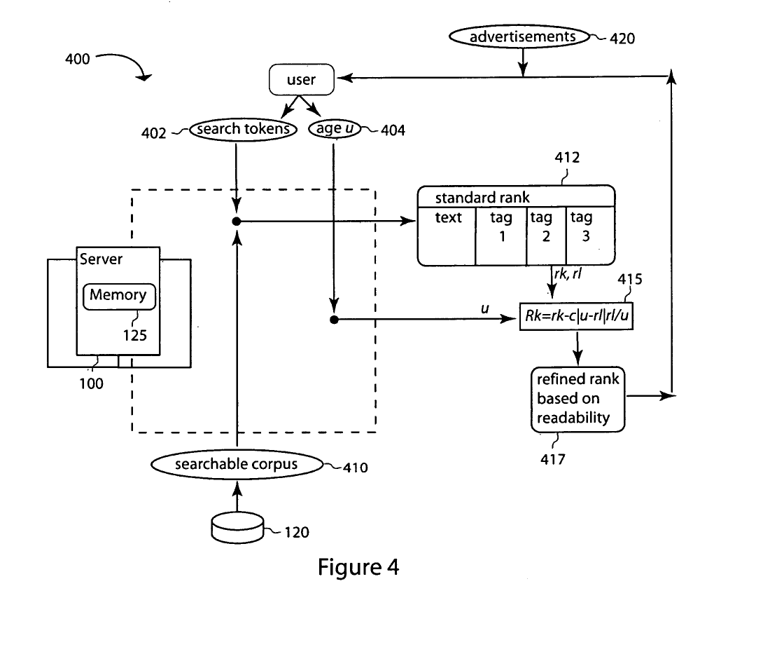

A search process 400 from the perspective of the user is illustrated in FIG. 4. The user enters search terms 402 and (voluntarily) enters information relevant for assessing whether a certain document is appropriate for the user's readability level. This may be accomplished directly, i.e., by the user specifying his age and/or grade level 404, or indirectly, e.g., by setting the position of a graphical slide switch representing reading difficulty (with each possible switch position corresponding to a readability level). Alternatively, the user's reading level may be inferred from the query 402 itself (see, e.g., Liu et al., “Automatic Recognition of Reading Levels from User Queries,” Proceedings of Sheffield SIGIR 2004 at p. 548, the entire disclosure of which is hereby incorporated by reference).

This information 402, 404 is communicated to server 100, which searches an indexed corpus 410 (described previously) of documents stored on hard drive(s) 120 for documents containing the search terms. Establishing relevancy and sorting search results based on the number of occurrences of the search token(s) in each document contained in the searchable corpus is well established in the industry. A ranked list 412 of search results is generated, where the rank is represented by a number rk and large numbers imply higher rank or greater relevancy; the rank is based on metrics consistent with standard practices. In addition, the search results are refined based on the users' reading level (age) and the readability scores indexed for each entry in the corpus.

Refinement of the ranking of documents in the list can be accomplished, for instance, by adding, to the old ranking number rk of the document, an additional term that reflects the age of the user and the readability score for each document. This yields a refined ranking number 415 based on the formula:
Rk=rk−c×|u−rl|×rl/u
where |u—rl| is the absolute value of the difference between the user's age u and the calculated readability level rl, and c is a constant which is to be optimized empirically. From the several stored readability scores rl obtained with different formulae as described above, the comparison is made with the one resulting from a formula applicable to the user's age. The factor rl/u, i.e., the ratio of document readability level and user age, serves to prefer inappropriately simple texts over excessively difficult documents. The user is finally given a refined ranking 417 of links to articles which match both his search queries and his reading abilities.

Numerous variations are, of course, possible. In one alternative embodiment, retrieval as well as ranking are based in part on reading level. For example, the corpus 410 of searchable documents may be segmented according to reading level, and searching based on the user's query 402 is confined to documents that have been assigned reading levels at or below that of the user. The degree to which query relevance and readability influence ranking and/or searching can also be varied, e.g., by a weighting assigned by the user. In particular, the constant c used to determine the refined ranking number 415 can be varied to determine the weight assigned, in ranking documents, to reading level. It is also possible to simply exclude documents whose reading levels are too high (or too low) from the list 417 entirely.

Furthermore, it is possible that the refined ranking number Rk will have an entirely different, possibly non-linear, functional dependence on rk, rl, and u than in the above formula. The specific formula given above, in other words, is a non-limiting example of a formula for a refined ranking score. It serves to illustrate merely one way of combining the user age and readability of the document with the old ranking number into a new ranking number which reflects, in addition to relevancy, the appropriateness of the document to the user's reading level.

The list of documents 417 may, depending on the revenue model of the implementing entity, be returned to the user as a web page that includes advertisements 420. In such embodiments, the user's age can guide the selection of user-appropriate ads, either by itself or in conjunction with the search query 402. (If the user has not entered her age, her specified or estimated reading level can be correlated with an assumed age.) The use of search queries to guide ad selection and placement is well known; see, e.g., U.S. Pat. No. 6,269,361 (the entire disclosure of which is hereby incorporated by reference). Typically, a search engine will communicate either the query itself, or the results of some analysis performed thereon, to an ad server. The search engine may also send placement parameters defining the dimensions of the ad space on the results screen that will be sent to the querying user. Based on these parameters, the ad server will return a targeted ad to the search engine, which inserts it into the results screen and serves the page to the user. By tying advertisement displays to both the search tokens 402 and the user's age 404 as determined from his reading level e.g., by providing the user's reading level or inferred age as a parameter to an ad server—search-related advertisements can be made significantly more effective.

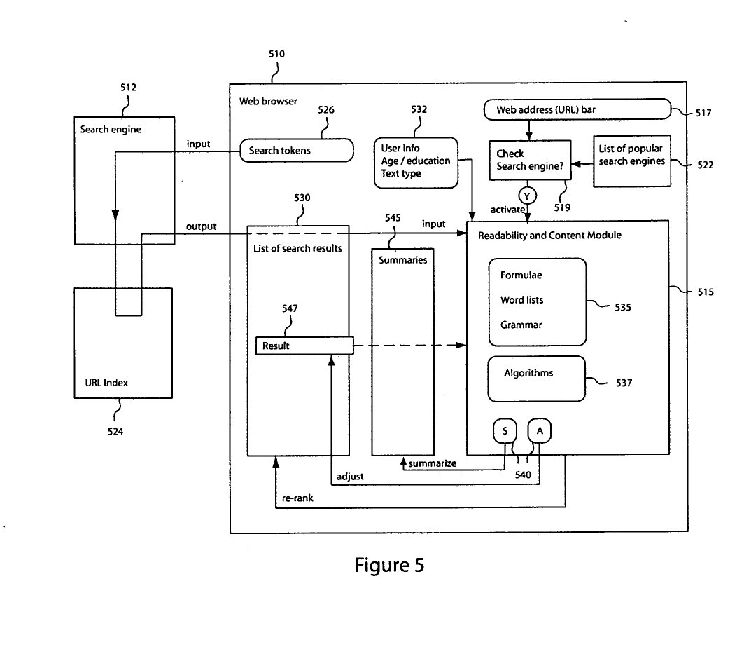

The foregoing discussion reflects server-based generation of the readability-modified search rankings. This is by no means essential to the operation of the invention. It is equally possible to perform these functions on the client machine, e.g., with functionality incorporated as a “plug-in” to a standard web browser. In this way, searching can be carried out on any commercial search engine, with results modified on the client machine in accordance with the invention. A suitable implementation of this approach is shown in FIG. 5, which illustrates schematically the interplay between a standard web browser 510 located on a client computer and a commercial search engine 512 implemented on a remote server, with results modified by a readability and content module (RCM) 515 operating in conjunction with the browser 510. When the user enters a new URL in the address bar 517 of browser 510, or the URL changes due to the user's interaction with the content of a web site (e.g., by clicking on a link, or by entering search tokens in a search bar and starting the search), a URL check routine 519 determines whether a search engine is being accessed. This can be accomplished by comparing the address input with a list 522 of popular search engines, or by scanning it for the character ‘?’, which distinguishes search URLs. If the accessed web site is identified as that of a search engine, RCM 515 is activated.

The search engine 512 then searches an index 524 of documents (which has been previously extracted from the Internet with an indexer) for the search tokens 526 entered by the user, and returns to the web browser 510 as its output a list 530 of links to web documents that contain the search tokens. If the user has further entered her age and/or education level or the required content type (e.g. news, blog, commercial site, scientific publication, personal home page etc.) in the designated readability and content field 532, this information, along with the list 530, is forwarded to the RCM 515 for re-ranking.

Since most search engines yield for each result not only a link to the corresponding web site but also a short excerpt of the document, a quick re-ranking can be performed based on an analysis of these few lines. Alternatively, the browser 510 can follow the links provided by the search engine, and retrieve a certain portion of each of the corresponding web documents (e.g., the first thousand words) for a more thorough readability and/or content analysis. This process will take more time, but probably deliver better results. The re-ranked list 530 is finally displayed by the browser.

RCM 515 typically includes a plurality of libraries 535 of word lists, grammatical structures, and readability and content-type formulae; algorithms 537 for the determination of text metrics and grammatical structures, and for the assignment of readability and content-type scores with formulae based on this information; and, in some embodiments, a plurality of switches 540 for the enabling or disabling of special features such as summary generation (S) and readability adjustment (A). If the summary feature is enabled, summaries 545 of the web documents contained in list 530 are compiled and displayed with the links. If the readability adjustment feature is enabled, a text document 547, which has been selected by the user, is compiled into a document having the same content, but in a language more appropriate to the age and education entered in field 532. Adaptation of a document to a lower reading level can be accomplished, for example, by replacing difficult words with synonyms that are contained in the standard vocabulary corresponding to this lower reading level, and by breaking long sentences with a complex grammatical structure down into several shorter sentences according to certain rules. The following example illustrates the principle:

1. Whereas most children have Internet access, only few take advantage of the existing search engines.

2. Most children have Internet access. However, only few take advantage of the existing search engines.

Here, the subordinate clause introduced with whereas in sentence 1 is turned into a separate sentence in sentences 2. Obviously, readability adjustment is possible in both directions, i.e. toward a simplification or toward an elaboration of the sentence structure and vocabulary.

In various embodiments the functional modules of the invention may be provided as either software, hardware, or some combination thereof. For example, the system may be implemented on one or more server-class computers, such as a PC having a CPU board containing one or more processors such as the Pentium or Celeron family of processors manufactured by Intel Corporation of Santa Clara, Calif., the 680×0 and POWER PC family of processors manufactured by Motorola Corporation of Schaumburg, Ill., and/or the ATHLON line of processors manufactured by Advanced Micro Devices, Inc., of Sunnyvale, Calif. The processor may also include a main memory unit for storing programs and/or data relating to the methods described above. The memory may include random access memory (RAM), read only memory (ROM), and/or FLASH memory residing on commonly available hardware such as one or more application specific integrated circuits (ASIC), field programmable gate arrays (FPGA), electrically erasable programmable read-only memories (EEPROM), programmable read-only memories (PROM), programmable logic devices (PLD), or read-only memory devices (ROM). In some embodiments, the programs may be provided using external RAM and/or ROM such as optical disks, magnetic disks, as well as other commonly storage devices.

For embodiments in which the invention is provided as a software program, the program may be written in any one of a number of high level languages such as FORTRAN, PASCAL, JAVA, C, C++, C#, LISP, PERL, BASIC or any suitable programming language. Additionally, the software can be implemented in an assembly language and/or machine language directed to the microprocessor resident on a target device.

It will therefore be seen that the foregoing represents a highly extensible and flexible approach to utilizing readability criteria in connection with document searching. The terms and expressions employed herein are used as terms of description and not of limitation, and there is no intention, in the use of such terms and expressions, of excluding any equivalents of the features shown and described or portions thereof, but it is recognized that various modifications are possible within the scope of the invention claimed. For example, the various modules of the invention can be implemented on a general-purpose computer using appropriate software instructions, or as hardware circuits, or as mixed hardware-software combinations. Moreover, although the above-listed text and drawings contain titles and sub-headings, it is to be understood that these title and sub-headings do not, and are not intended to limit the present invention, but rather, they serve merely as titles and headings of convenience.

What is claimed is:

1. A method of ranking a set of documents according to readability criteria pertaining to a user, the method comprising the steps of:
a. receiving criteria indicative of a user's reading level;
b. receiving a user-supplied search query;
c. retrieving a list of documents relevant to the search query, the documents having contents;
d. analyzing the document contents against the received criteria; and
e. ranking the list of documents based at least in part on the analysis.

2. The method of claim 1 wherein the list of documents is ranked based on the analysis and relevance to the search query.

3. The method of claim 1 wherein steps (a) through (e) are performed at a client computer.

4. The method of claim 1 wherein steps (a) through (e) are performed at a server computer.

5. The method of claim 1 further comprising the steps of successively retrieving and analyzing at least a portion of each document.

6. The method of claim 2 wherein the ranking is based on a weight assigned to the analysis, the weight determining a degree to which the analysis influences ranking.

7. The method of claim 2 wherein documents having reading levels above the user's reading level are excluded from the list.

8. The method of claim 2 wherein documents having reading levels below the user's reading level are excluded from the list.

9. The method of claim 1 wherein the criteria comprise at least one of age or reading level.

10. The method of claim 1 wherein the user indicates a degree of reading difficulty using a graphical token and the criteria are derived therefrom.

11. The method of claim 10 wherein the graphical token is in the form of a slide switch, the slide switch having positions corresponding to different reading levels.

12. The method of claim 1 wherein the criteria are inferred from the user-supplied search query.

13. The method of claim 1 further comprising the step of providing the ranked list of documents to the user along with advertising selected, at least in part, based on the criteria.

13. A method of searching a set of documents according to readability criteria pertaining to a user, the method comprising the steps of:
a. receiving, at a client computer, criteria indicative of a user's reading level;
b. receiving, at the client computer, a user-supplied query; and
c. receiving, at the client computer, a list of documents relevant to the query and ranked based at least in part on the received criteria.

14. The method of claim 13 wherein the list of documents is ranked based on the analysis and relevance to the search query.

15. The method of claim 14 wherein the client computer successively retrieves and analyzes at least a portion of each document in the list via a computer network.

16. The method of claim 13 wherein the criteria comprise at least one of age or reading level.

17. A method of targeting advertisements in conjunction with return of search results, the method comprising the steps of:
a. receiving criteria indicative of a user's reading level;
b. receiving a user-supplied search query;
c. retrieving a list of documents relevant to the search query, the documents having contents; and
d. providing a list of documents to the user along with advertising selected, at least in part, based on the criteria.

18. The method of claim 17 wherein the criteria comprise at least one of age or reading level.

19. The method of claim 17 wherein the user indicates a degree of reading difficulty using a graphical token and the criteria are derived therefrom.

20. The method of claim 19 wherein the graphical token is in the form of a slide switch, the slide switch having positions corresponding to different reading levels.

21. The method of claim 17 wherein the criteria are inferred from the user-supplied search query.

22. A system for ranking a set of documents according to readability criteria pertaining to a user, the system comprising:
a. a module for determining a user's reading level;
b. a search application for receiving a user-supplied search query and, based thereon, retrieving a list of documents relevant to the search query, the documents having contents; and
c. a module for analyzing the document contents against the received criteria and ranking the list of documents based at least in part on the analysis.

23. The system of claim 22 wherein the module ranks documents based on the analysis and relevance to the search query.

24. The system of claim 22 wherein the analysis module is configured to successively retrieve and analyze at least a portion of each document.

25. The system of claim 22 wherein the analysis module ranks documents based on a weight assigned to the analysis, the weight determining a degree to which the analysis influences ranking.

26. The system of claim 22 wherein the analysis module excludes from the list documents having reading levels above the user's reading level.

27. The system of claim 22 wherein the analysis module excludes from the list documents having reading levels below the user's reading level.

28. The system of claim 22 wherein the criteria comprise at least one of age or reading level.

29. The system of claim 22 wherein the analysis module infers the criteria from the user-supplied search query.

30. A system for targeting advertisements in conjunction with return of search results, the system comprising:
a. a module for determining a user's reading level;
b. a search application for receiving a user-supplied search query and, based thereon, retrieving a list of documents relevant to the search query, the documents having contents; and
c. an analysis module for facilitating selection of advertising based, at least in part, on the analysis.

31. The system of claim 30 wherein the analysis module returns a web page including the list of documents and the advertising.

32. A computer-readable medium comprising executable instructions for ranking a set of documents according to readability criteria pertaining to a user, the medium comprising instructions for:
a. receiving criteria indicative of a user's reading level;
b. receiving a user-supplied search query;
c. retrieving a list of documents relevant to the search query, the documents having contents;
d. analyzing the document contents against the received criteria; and
e. ranking the list of documents based at least in part on the analysis.
